(19) United States
(12) Patent Application Publication
(10) Pub. No.: US 2024/0317359 A1
(43) Pub. Date: Sep. 26, 2024

(54) VESSEL AND SYSTEM ADAPTED FOR COLLECTION OF DISTANT WINDPOWER

(71) Applicant: FARWIND ENERGY, NANTES (FR)

(72) Inventor: Aurelien BABARIT, NANTES (FR)

(73) Assignee: FARWIND ENERGY, NANTES (FR)

(21) Appl. No.: 18/577,676

(22) PCT Filed: Jul. 7, 2022
(86) PCT No.: PCT/EP2022/068739

§ 371 Date: Jan. 8, 2024

(30) Foreign Application Priority Data
Jul. 6, 2021 (FR) 2107321

(51) Int. Cl. B63B 1/10; B63H 9/02; B63J 3/04

(52) U.S. Cl. CPC B63B 1/10; B63H 9/02; B63J 3/04; B63B 2001/102; B63J 2003/046

(57) ABSTRACT

The invention pertains to a Pacific prao-type amphidromic multihull vessel (100), comprising a hull (101) and a float (102) parallel to the hull, the float and the hull being linked by a beam (130) the hull carrying a Flettner-type rotary rigging (111, 112) capable of producing a thrust perpendicular to both its spinning axis (110) and a wind direction (180), that in absence of wind is heeled by an angle α toward the float. The invention also pertains to a system implementing such a vessel for collecting windpower into a storage battery housed in the float as well as a method for boarding and disembarking such a battery.

### TECHNICAL FIELD

The invention pertains to a vessel and a system capable of nomadically collecting offshore wind energy, storing it in a chemical form, in a battery, as dihydrogen, in synthetic fuel or e-fuel, and then returning it to a collection point, such as onshore.

Such a vessel has the advantage of moving toward windy areas and following depressions in order to maximize the load factor of electricity production, while eliminating the anchoring needs of fixed wind turbine-type structures.

### BACKGROUND ART

So-called offshore wind power installations are deemed to allow higher load factors to be obtained than onshore wind power installations.

The load factor is defined as the ratio of the electrical energy actually produced by a generator, driven by wind power during a reference period, usually 1 year, by the theoretical amount of energy that would have been produced over the same reference period if the generator had produced at its full power over the same period.

Thus, this load factor is a composite parameter that takes into account both the performance of the means itself, that is to say its production power according to the wind speed for a wind turbine, shutdowns for maintenance and failure rates over the same reference period, but also the environment in which this means produces, which defines the frequency and intensity of wind episodes.

Thus, onshore wind power exhibits load factors comprised between 20% and 25%, while offshore wind power load factors are comprised between 40% and 60%, favored by the steadiness and the power of offshore winds.

However, the development of offshore wind power is limited by several factors.

The depth of the ocean floor, that beyond a certain depth increases installation costs very significantly.

The distance from the coast, which requires pulling submarine cables to bring the produced electricity.

Thus, offshore wind power installations remain close to the coast where their operation competes with rival uses (navigation, fishing, etc.) and where they cannot take full advantage of the steadiness and the power of the winds.

There are also floating wind turbine systems, installed offshore and storing the energy they produce in the form of dihydrogen by electrolysis of water. The hydrogen thus produced is collected from time to time by a suitable vessel and brought back to the coast.

However, in the latter case, production remains dependent on the weather at the mooring location of the wind turbine, and of the collection system.

Co-pending patent application FR2101157 describes a catamaran-type vessel provided with a rotating Flettner-type rig, suitable for the nomadic collection of offshore wind energy, and for storing this energy in a chemical form.

This vessel is equipped with hydro turbines under its floats, which hydro turbines are rotated as the vessel moves and produce electricity.

The vessel thus enters a port from time to time to unload the energy thus stored.

If this system gives overall satisfaction, it may still be improved for its effectiveness.

Thus, the Flettner type rigging, producing a thrust both perpendicular to the wind and to the axis of rotation of the rotor, means that under ideal wind conditions with respect to electrical production, the vessel heels under the effect of the wind, which reduces the efficiency of the rigging, the axis of rotation of which is then no longer perpendicular to the wind.

Moreover, the dimensions of the vessel are such that only substantial port facilities are able to accommodate it for the disembarkation of energy storage means.

Document US 2015/027125 describes a catamaran-type vessel comprising 4 Flettner rotors and reversible hydro turbines, making it possible to use the latter to produce and store electricity when the vessel is moved by the sails and to use this stored energy to propel the vessel in the absence of wind, using the hydro turbines in a propulsion mode.

Document WO 2010/00277 describes a device for producing electrical energy from sea currents comprising a floating part and a submerged part.

Document US 2005/0252764 describes a multihull sailing vessel with hydro turbines to produce electricity during the movement of the vessel pushed by its rigging and to produce dihydrogen by electrolysis of water by means of the electricity thus produced.

### SUMMARY OF THE INVENTION

The invention aims at solving the shortcomings of the prior art and to this end pertains to a Pacific prao-type amphidromic multihull vessel, comprising a hull producing a first displacement according to its draft and a float parallel to the hull producing a second displacement according to its draft, the float and the hull being linked by a beam and separated from each other by a distance y, the hull carrying a Flettner-type rotary rigging capable of producing a thrust perpendicular to both its axis of rotation and a wind direction, wherein the beam connects the float to the hull in a relative verticale position of the float with respect to the hull so that the vessel being loaded and in the absence of wind, the draughts of the hull and the float are such that the vessel is inclined by a heeling angle α towards the float.

Thus, the counter heeling enables to straighten the vessel in favorable wind conditions and to increase the efficacy of the Fletner rigging.

The invention may be implemented according to the embodiments and variants exposed hereafter, which are to be considered individually or according to any technically operative combination.

According to an embodiment, angle α is greater than or equal to 8°.

This embodiment is suitable for operation of the vessel in a wind speed range comprised between 8 and 30 knots (3 to 7 beauforts).

According to an embodiment, the hull comprises two rotating Flettner-type rigs.

Advantageously, each Flettner rig comprises 2 sections superimposed along its axis of rotation and comprises at the junction between said two sections a cable stay connection between the rig and the float.

This embodiment makes it possible to distribute the roll tilting torque exerted at the foot of each Flettner rig.

According to a variant the Flettner rotary rigging comprises a central mast, and a plurality of sections superimposed along its axis of rotation, each section of the plurality comprising a catenoid-shaped canvas, stretched between two coaxial hoops centered on the axis of rotation, connected to the central mast and separated from each other parallel to the axis of rotation of the rotary rigging, so as to exert on the canvas a traction parallel to the axis of rotation of the rotary rigging, said canvases forming the aerodynamic surface of the rotary rigging.

This variant makes it possible to lighten the Flettner rigging.

According to an advantageous embodiment, the float comprises ballasts and means for filling and emptying said ballasts.

Thus, the heeling of the vessel may be controlled by the ballasts.

Advantageously, the hull comprises an immersed hydroturbine configured to produce electricity by the motion of the vessel and the float comprises a storage battery configured to store the electricity produced by the hydroturbine, the storage battery being removably connected to the float in a housing by locking means enabling it to be loaded and unloaded.

This feature in combination with the ability to ballast the float, enables to exchange the battery offshore when the vessel is ay anchor without the need to reaching a port.

The invention also pertains to a wind energy collection system in the form of electricity comprising a vessel according to the invention and a mooring buoy, wherein the storage battery comprises means for enabling its buoyancy.

Advantageously, the vessel comprises a winching device between the hull and the float to loading and unloading the storage battery of the float.

According to an advantageous embodiment, the floating storage battery of the system of the invention comprises propulsion means.

In the event that the floating storage battery does not comprise its own propulsion means, the system comprises a second mooring buoy intended for the storage battery, so as to moor said battery during an exchange.

According to an advantageous embodiment the system further comprises a telecommunications satellite and a control station remote from the vessel, the vessel and the control station comprising means for establishing a radio link with the telecommunication satellite, the control station controlling the vessel remotely via the radio link.

This embodiment allows energy to be collected without a crew being on board the vessel.

The invention also pertains to a method for unloading a storage battery of a system according to the invention, comprising the steps of: i) mooring the vessel to the mooring buoy; ii) ballasting the float so as to tilt the vessel; iii) removing the storage battery from its housing by winching; iv) carrying the storage battery away.

The invention also pertains to a method for loading a storage battery onto the vessel of a system according to the invention, comprising the steps of: a) mooring the vessel to the mooring buoy; b) ballasting the float so as to tilt the vessel; c) bringing the storage battery between the float and the hull of the vessel; d) winching the storage battery in its float housing; e) emptying the ballast of the float and locking the storage battery in its housing.

### BRIEF DESCRIPTION OF THE DRAWINGS

The invention is implemented according to the preferred embodiments, in no way limiting, exposed hereafter with reference to FIG. 1 to FIG. 11 in which:

FIG. 1 represents, on a schematic perspective view, an exemplary embodiment of the vessel of the invention;

FIG. 2 schematically shows the vessel of the invention according to a front view in the absence of wind;

FIG. 3 is the same view as FIG. 2 but in the presence of wind and includes a schematic detail view of the junction between the mast and a stay;

FIG. 4 shows the vessel of the invention seen from the front before ballasting the float;

FIG. 5 shows, according to the view of FIG. 4, the winching in or out of its housing of a storage battery after ballasting the float;

FIG. 6 shows according to a top view a synopsis of the method for exchanging a storage battery in the system of the invention;

FIG. 7 is a schematic profile view of an exemplary embodiment of a battery-boat;

FIG. 8 schematically represents the cross-sections at the beams of the hull and float, not linked together, and their individual buoyancy positions;

FIG. 9 shows a schematic cross-section at the beam of the vessel and the relative float and hull flotation positions when they are connected by a linking member;

FIG. 10 is a partial sectional view AA defined in FIG. 3 of an example of a Flettner rigging.

FIG. 11 schematically depicts an embodiment of the system comprising a satellite and a distant control station.

For the sake of clarity, the figures are schematic and represent each characteristic of the invention individually. Unless specifically indicated, all of these characteristics may be combined in part or in full on the same vessel.

### DESCRIPTION OF EMBODIMENTS

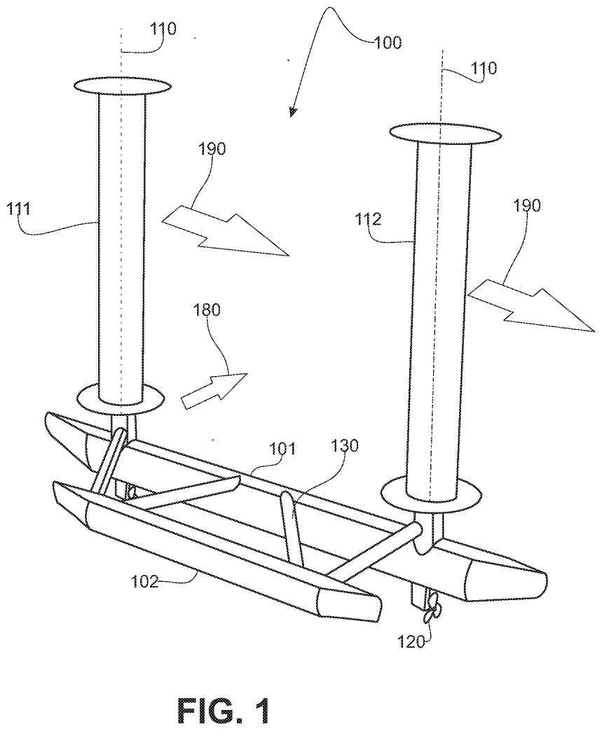

FIG. 1 according to an exemplary embodiment, the vessel (100) of the invention is a multihull vessel designed according to a “prao Pacifique” type architecture, comprising a hull (101) and a float (102) parallel to said hull and connected thereto by one or more beams (130).

Unlike trimarans and more classic catamarans, prao does not turn. It is amphidromic, that is to say, it always sails the float (102) in the wind in counterweight.

This particularity is used to balance the effect of the wind on the rigging as explained below.

The hull (101) carries, according to this exemplary embodiment, a rigging composed of one or more Flettner rotary riggings (111, 112) ecch comprising a rotor spinning about a substantially vertical axis (110).

Each Flettner rig (111, 112) produces a thrust (190) whose direction is perpendicular to the spinning axis (110) of the rotor and to the direction of the wind (180).

The hull (101) comprises in its submerged part one or more hydro turbines (120) which are spun by the displacement of the vessel under the effect of the wind and which produce electricity via a generator coupled to the hydro turbines.

The float (102) is always wind-oriented and in counterweight, so the hydro turbines are always submerged to produce electricity.

According to an exemplary embodiment, the length of the vessel is 80 m, its width is 21 m, the length of the float (102) is 60 m and the height of the Flettner rigs (111, 112) is 50 m for a diameter of 7 m, the rotors being driven in rotation at a speed comprised between 0 and 130 revolutions per minute.

Such a vessel is able to track windy areas on the high seas for to harvesting energy and producing electricity.

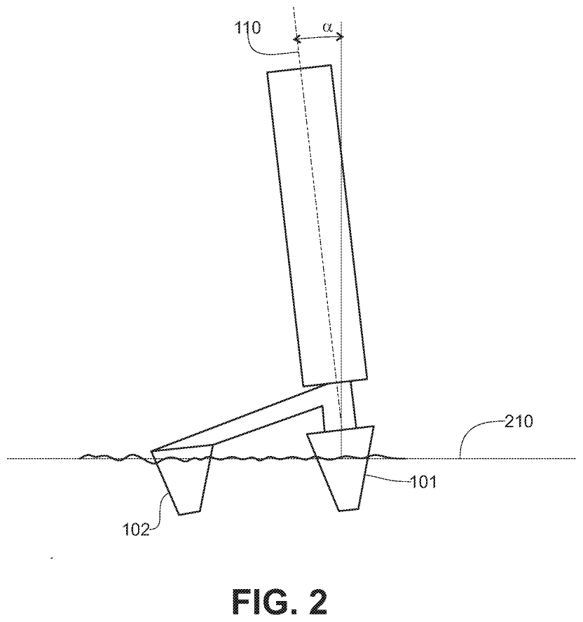

FIG. 2, advantageously, in the absence of wind, the weight and shape of the float (102) and of the hull (101) are such that the vessel heels and the axis of rotation (110) of the rotors of the Flettner rigging is inclined by an angle α towards the float (102) with reference to a line perpendicular to the waterline (210).

Typically a is of the order of 8°.

To this end, FIG. 8, when the hull (101) taken alone, that is to say not connected to the float (102) by a beam, is theoretically immersed while it is subjected to its own weight and to that of the elements it carries, in particular the Flettner rigs, it sinks by a certain depth (801) with respect to the level of the water (800) according to its shape and its draft, so that the Archimedes thrust balances its total weight.

In the same way, the float (102) taken individually, that is to say not connected to the hull by a beam, and subjected to its own weight as well as to that of the elements it carries, in particular a battery for storing the electricity produced, sinks a certain depth (802) with respect to the water level (800), a depth depending on its shape and its draft, so that the Archimedes thrust balances its total weight.

It is thus easy, under these theoretical conditions, to define a height difference h (803) between, for example, an upper part of the hull (101) and an upper part of the float (102), both immersed individually.

FIG. 9, to obtain a heeling angle α when the vessel is at rest and in the absence of wind, the beam (130) connecting the float (102) to the hull (101) is installed such that, the hull and the float being distant by a distance y (904), said beam connects the float to the hull such that the height difference (903) between the upper part of the hull (101) and the upper part of the float is equal to (h−x). Under these conditions, as a first approximation, tan(α)=x/y.

If y=20 m and x=3 m, α=8°.

Launched, the vessel will then tilt at an angle close to a until the Archimedes thrusts applied to the hull and float balance its weight.

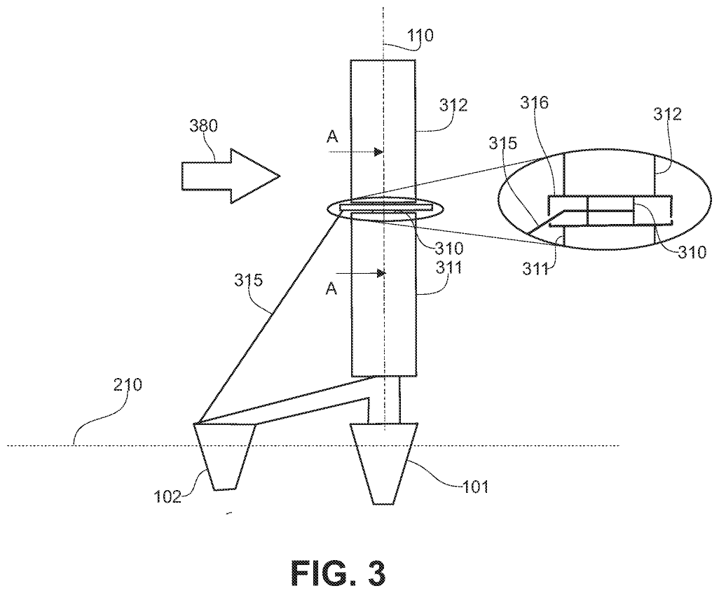

Thus, FIG. 3, in sailing conditions, the float (102) being placed in the wind, the aerodynamic force exerted by the apparent wind (380) on the Flettner rigs, exerts a capsizing torque which tends to straighten the vessel, so that the spinning axis (110) of the rotors of said rigs is substantially vertical in favorable wind conditions, typically for crosswinds whose speed is between 8 knots (4.12 m·s⁻¹) and 30 knots (15.43 m·s⁻¹), the rotor being vertical for a crosswind of 18 knots (9.26 m·s⁻¹).

As the Flettner rig produces a thrust perpendicular to the wind and perpendicular to the spinning axis (110) of the rotor, it is more effective under these conditions.

Under these conditions, the mast feet of the Flettner rigs are subjected to a bending torque around the thrust axis.

To this end, according to an advantageous embodiment, a Flettner rig comprises several sections (311, 312) superimposed along the spinning axis (110) of the rotor around the mast (310).

Between all or part of said sections (311, 312) the mast is connected to the float (102) via one or more stays (315) so as to limit the concentration of the bending torque at the foot of the mast.

Advantageously, the junction between a stay (315) and the mast (310) comprises a cowling (316), for example connected to the rotors (311, 312) so as to limit the unfavorable aerodynamic effects of this junction.

According to an exemplary embodiment, the Flettner rigging is lightened so as to keep the center of gravity of the vessel as low as possible, thus improving its stability, limiting the energy required to spin the rotors, and limiting the ballasting volumes perform the operations of loading and unloading the battery as described below.

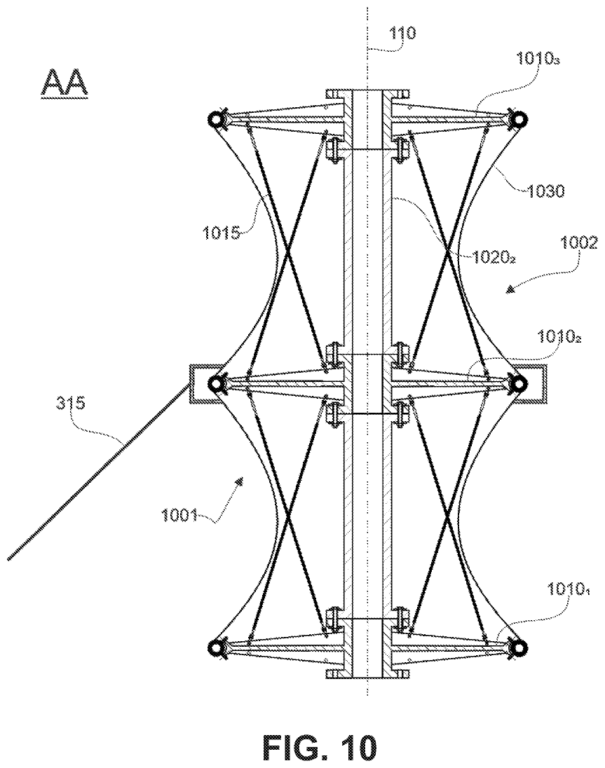

For this purpose, FIG. 10, and according to an exemplary embodiment, the Flettner rigs comprise several sections (1001, 1002) superimposed along the spinning axis (110) of the rotor.

Each section extends between two hoops (10101, 10102, 10103) separated from each other, parallel to the spinning axis of the rotor (110), by a tubular spacer (10201, 10202) to which they are connected in rotation by their central part, for example by bolting. These spacers assembled together via the central parts of the hoops, make the central mast, centered on the axis (110) of the rotor, which mast is driven in rotation when said rotor is used for the propulsion of the vessel.

Said hoops are circular and coaxial, centered on the spinning axis (110) of the rotor, and according to this embodiment, are of the same diameters without this last characteristic being a limitation.

The outer surface of the rigging consists of stretched canvases (1030). Each section comprises a canvas (1030) extending between two hoops and forming a substantially diabolo-shaped cylindrical surface, the canvas thus stretched describing a catenoid.

This catenoid shape results from an equilibrium configuration taken by the canvas under the effect of the tension applied to it by an installed traction, exerted by the hoops parallel to the spinning axis of the rotor.

The high tension of the canvas gives it the rigidity required for it to serve as an aerodynamic surface for the Flettner rigging, the spacers, hoops and canvases are driven in rotation when said rotor is spinning.

Internal stays (1015) extending between two directly superimposed hoops and in the volume between the spacer and the fabric, complete the rigidity of the assembly and in particular its torsional rigidity.

This construction makes it possible to limit the mass and inertia in rotation of the Flettner rigging.

The spacers and hoops are advantageously made of a light alloy or of a composite material with fibrous reinforcement.

According to non-limiting exemplary embodiments, the canvas (1030) is made, for example, of a fluoropolymer such as a polytetrafluoroethylene (PTFE), an ethylene tetrafluoroethylene (ETFE), a polyvinylidene fluoride (PVDF) chosen for their resistance to environmental conditions and their stability, or a canvas of natural fibers, such as cotton, linen, or polymer fibers, the fabric optionally being reinforced with a weft of glass or carbon fibers, which fabric is coated with a fluoropolymer film.

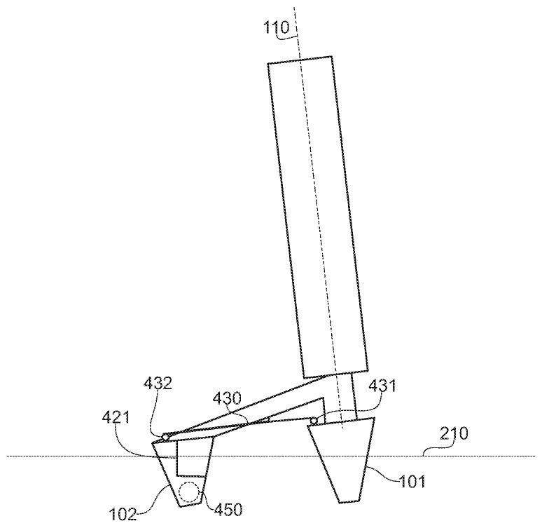

FIG. 4, according to an advantageous exemplary embodiment, the float (102) comprises a location (421) configured to receive a storage battery and comprises a ballast volume (not shown) so that the heel of the vessel can be modified by filling or emptying said ballast.

Said storage battery is intended to store the electrical energy produced by the hydro turbines to be then transported to a place of consumption of this electrical energy, on land or at sea, but separate from the collection vessel.

According to an exemplary embodiment, the battery may be of the Li-on type.

According to an exemplary embodiment, the vessel further comprises one or more batteries, also rechargeable by hydro turbines or by other means such as solar panels, or if necessary, by the storage battery, but of smaller capacity, and intended to power the systems on board the vessel.

According to a non-limiting exemplary embodiment, the float may displace a volume of 1100 m³, the storage battery of 20 MWh capacity corresponds to a displacement volume of 300 m³ and the ballast volume is 50 m³.

Thus, by the use of the ballast, the heeling angle α may be changed while the vessel is mooring, so as to facilitate the boarding and disembarkation of the storage battery.

To this end, the vessel includes one or more guiding lines (430) extending between the hull (101) and the float (102) between winches (431, 432), which guiding lines enable a floating storage battery to be towed into or out of its location (421) in the float.

Thus, the invention also relates to a system comprising the vessel described above and one or more floating storage batteries.

A floating storage battery comprises a battery, for example of 20 MWh capacity, provided with means enabling its flotation.

According to embodiment variants said floating battery may comprise or not its own propulsion means. When it comprises its own propulsion means, it is designated as a “battery boat”, in the other case the floating storage battery is moved via a tugboat.

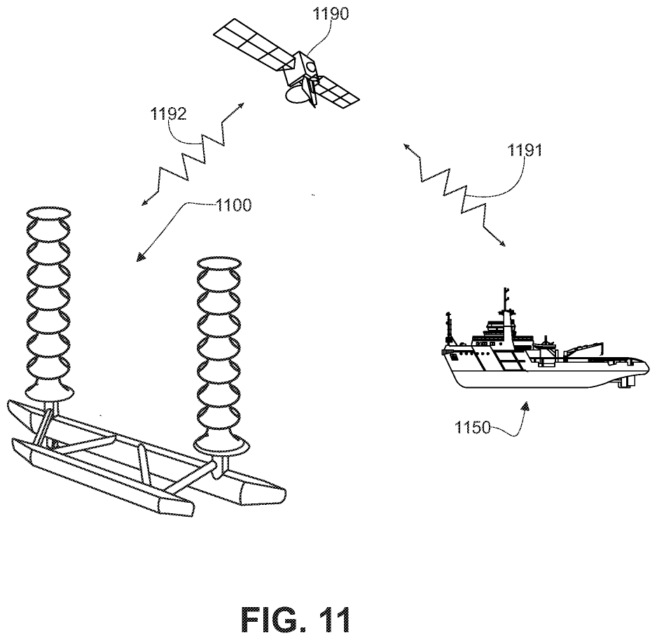

FIG. 11, according to an exemplary embodiment the system comprises a communication satellite (1190), the vessel (1100), here equipped with light Flettner rigs without this configuration being exhaustive, comprises means to establish a satellite connection (1192) with said satellite (1190).

The system further comprises a control station (1150) located on land or in a surface building (1150), provided with means for communicating with the vessel (1100) via its own satellite link (1191).

According to this exemplary embodiment, the vessel does not include a crew on board to track windy areas and to harvest energy.

Thus, the collection vessel is remotely piloted from the control station according to the weather forecast so as to follow the wind. A control station is able to remotely control several collection vessels so as to cover a very wide geographical area.

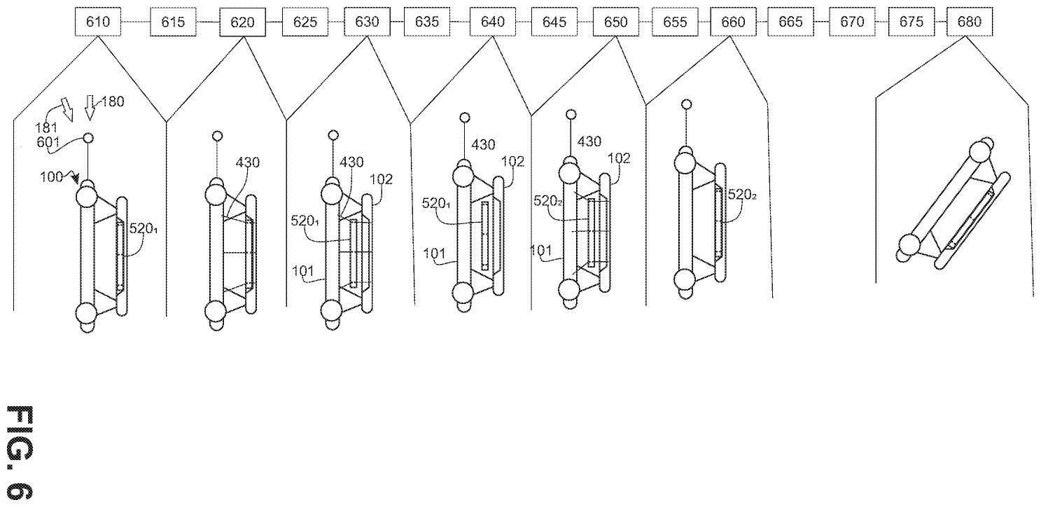

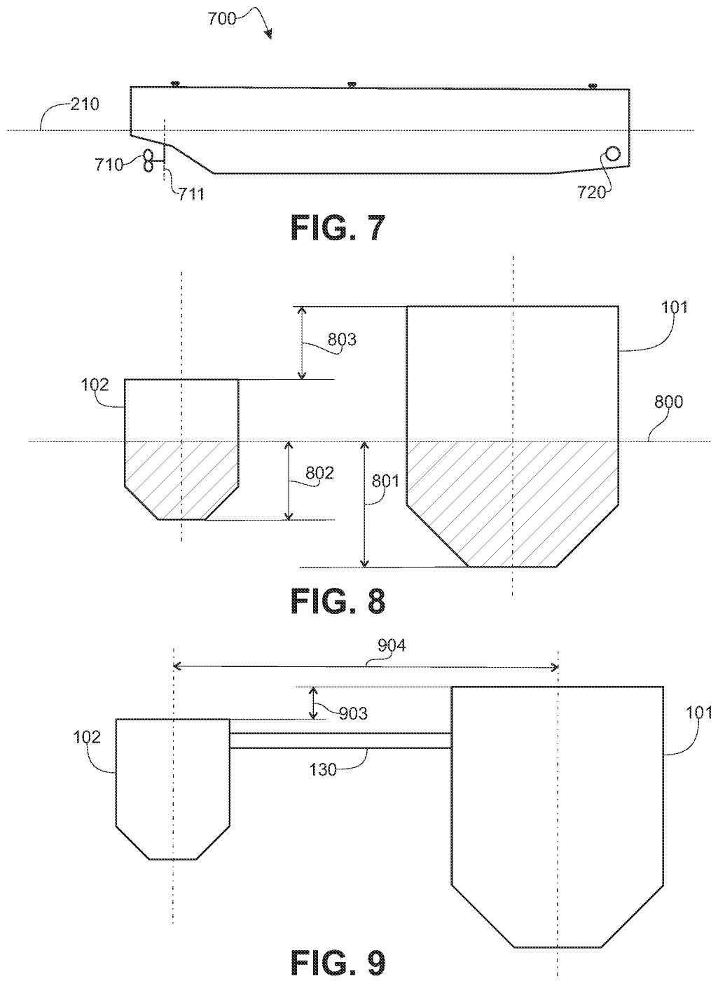

FIG. 7, according to an exemplary embodiment, a battery boat (700) comprises a main thruster (710) of the “pod” type comprising an electric motor and capable of being oriented along at least one axis (711) and a bow thruster (720) so as to give it good maneuverability.

The propulsion means of the battery boat are powered by the battery itself or by auxiliary batteries, which are recharged, for example, when the battery boat is at berth or by solar panels carried by said battery.

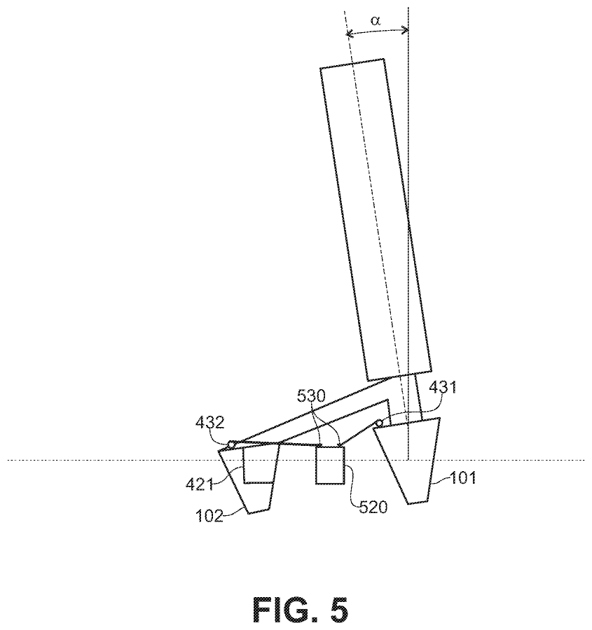

FIG. 5, according to an exemplary implementation of the boarding of a storage battery (520), with the vessel moored, the ballasts of the float (102) are filled so as to increase the heeling angle α towards the float, for example up to a value α=11°.

The floating storage battery (520) is placed between the float (102) and the hull (101) either by using its own propulsion means, in the case of a battery boat, or by a tugboat.

The floating storage battery (520) is then connected to the guiding lines by moorings (530) set on said battery and the action of the winches (431, 432) makes it possible to pull the latter into its housing (421).

The ballasts are emptied while the battery is held in position by the guidance lines, then the battery is locked in its housing.

The unloading is basically performed by the same operations in the opposite order, the vessel is ballasted, the battery is unlocked, it is then pulled out of its housing via the guiding lines, until it rests between the float and the hull, the floating storage battery being then taken out either by its own propulsion means or by a tugboat.

The advantage is that these steps do not require the vessel to be at berth to be carried out and may be performed offshore with the vessel at moor.

Thus, the invention also relates to a method for an exchange of batteries between a loaded storage battery and an empty storage battery, implementing the system described above and also comprising a mooring buoy, or several mooring buoys corresponding to storage battery exchange sites, easily distributed within a defined geographical area.

According to an exemplary embodiment, the vessel is piloted remotely during its electricity collection. In such a case, the implementation of the method described below comprises, before the first step, the boarding of a crew on board the vessel, able to take control of it and to carry out the maneuvers corresponding to some of the steps.

This crew is brought on board, for example by means of a pneumatic boat. Prior to its boarding, it is for example on board the “battery boat” or onboard the tugboat of the floating storage battery.

Prior to the following steps, a crew operator disconnects and electrically isolates the electrically charged floating battery (5201) for replacement.

FIG. 6, according to a mooring step (610), the vessel (100) is moored to the mooring buoy (601) intended for it. This step is for instance carried out by a crew member transported on board the vessel.

The vessel is moored facing the wind (180) and facing the waves (181).

Advantageously, during the period during which the vessel is moored, the hydro turbines, fed by the vessel's own means, may be used in a propelling mode to stabilize the vessel.

During a ballasting, step (615), the ballasts of the float are filled so as to bring the floating battery, still in its housing, close to its flotation height.

During a slinging step (620), the battery (5201) is secured to the guiding lines (430).

During an unlocking step (625), the floating battery is detached from its housing.

During a winching step (630) the floating storage battery (5201) is winched between the float (102) and the hull (101) of the vessel.

During a release step (635), the floating storage battery (5201) is detached from the guiding lines.

The slinging, winching and battery releasing maneuvers are carried out by the crew on board the vessel.

During an evacuation step (640), the electrically charged storage battery (5201) is taken by the tugboat or evacuates itself by its own propulsion means, the vessel is then ready to receive a new storage battery (5202).

During a positioning step (645) the new storage battery (5202) is placed between the hull (101) and the float (102) of the vessel.

During a slinging step (650) the new battery (5202) is secured to the guiding lines.

During a winching step (655), the new battery is winched in its housing.

During an release step (660) the new battery is detached from the guiding lines and pre-locked in its housing.

During a deballasting step (665) the ballasts of the float are emptied, and the vessel straightens.

During a locking step (670) the new battery is locked in its housing, and electrical connections are made.

During a unmooring step (675), the vessel is released from the buoy.

During a departure step (680) the crew leaves the vessel that leaves for a new energy collection campaign.

In the event that the floating batteries are devoid of propulsion means and are moved by a tugboat, the system comprises one or two additional mooring buoys making it possible to moor the new battery (5202) in particular during the evacuation step (640) and to moor the charged battery (5201) during the steps following this evacuation step.

The person skilled in the art organizes the steps presented above in the case of a simple disembarkation or embarkation operation without exchanging a storage battery.

The above implementation examples show that the invention achieves the intended purpose and that it makes it possible by “following the wind” to collect wind energy in a nomadic manner so as to achieve a high load factor without requiring significant fixed and port infrastructure, without modifying the landscape, without modifying the seabed and without submarine cables.

The system of the invention is flexible and makes it possible to supply several territories in a variable manner according to their variable needs, in particular islands. It can easily be assigned to serve another territory even remote and can be the subject of maintenance and repair operations at the port.

A system comprising one or more vessels and 2 or more exchangeable batteries makes it possible to supply electricity to a territory without intermittence.

1-15. (canceled)

16. A Pacific prao-type amphidromic multihull vessel, comprising a hull producing a first displacement according to a hull draft and a float parallel to the hull producing a second displacement according to a flaot draft, the float and the hull being linked by a beam and separated from each other by a distance y, the hull carrying a Flettner-type rotary rigging configured to producing a thrust perpendicular to both a rotation axis of the Flettner-type rotary rigging and a wind direction, the float comprising ballasts and a means for filling and emptying the ballasts, wherein the hull comprises an immersed hydro-turbine configured to producing electricity by a movement of the vessel and the float comprises a storage battery configured to storing the electricity produced by the hydro turbine, wherein the storage battery is removably connected to the float into a housing by locking means so that it can be loaded and unloaded from the float.

17. The vessel of claim 16, wherein the beam connects the float to the hull in a relative vertical position of the float with respect to the hull so that the vessel being loaded and in the absence of wind, the draft of the hull and the draft of the float are such that the vessel is inclined by a heeling angle α towards the float.

18. The vessel of claim 17, wherein the heeling angle α is greater than or equal to 8°.

19. The vessel of claim 16, wherein the hull comprises 2 rotating Flettner-type rotary riggings.

20. The vessel of claim 16, wherein a Flettner-type rotary rigging comprises 2 sections superimposed along the rotation axis of the Flettner-type rotary rigging and further comprising at a junction between the two sections a cable stay connection between the Flettner-type rotary rigging and the float.

21. The vessel of claim 20, wherein the cable stay connection at the junction between the two sections is protected by an aerodynamic cowling.

22. The vessel of claim 20, wherein the Flettner-type rotary rigging comprises a central mast, and a plurality of sections superimposed along the rotation axis of the Flettner-type rotary rigging, each section of the plurality comprising a catenoid-shaped canvas stretched between two coaxial hoops centered on the rotation axis of the Flettner-type rotary rigging and connected to the central mast the two coaxial hoops being separated from each other parallel to the rotation axis of the Flettner-type rotary rigging, so as to exert on the canvas a traction parallel to the rotation axis of the Flettner-type rotary rigging, the canvas forming an aerodynamic surface of Flettner-type rotary rigging.

23. A wind energy to electricity collection system comprising the vessel of claim 16 and a mooring buoy (601), wherein the storage battery comprises a means for ensuring its buoyancy.

24. The system of claim 23, wherein the vessel comprises between the hull and the float a winching device for loading and unloading the storage battery from the float.

25. The system of claim 23, wherein the storage battery comprises a propulsion means.

26. The system of claim 23, further comprising a second mooring buoy for the storage battery.

27. The system of claim 23, further comprising a telecommunications satellite and a remote control station of the vessel, the vessel and the control station comprising means for establishing a radio link with the telecommunications satellite, the control station controlling the vessel remotely via the radio link.
